(19) United States
(12) Patent Application Publication
(10) Pub. No.: US 2012/0315977 A1
(43) Pub. Date: Dec. 13, 2012

(54) GAME DEVICE, GAME DEVICE CONTROL METHOD AND INFORMATION RECORDING MEDIUM

(75) Inventor: Yuichi ASAMI, Minato-ku (JP)

(73) Assignee: KONAMI DIGITAL ENTERTAINMENT CO., LTD., Tokyo (JP)

(21) Appl. No.: 13/490,237

(22) Filed: Jun. 6, 2012

(30) Foreign Application Priority Data
Jun. 7, 2011 (JP) 2011-127625

(51) Int. Cl. A63F 13/00

(52) U.S. Cl. 463/24; 463/43

(57) ABSTRACT

In a game device, a task memory stores a plurality of game tasks for indicating the timing when a player is to input an operation instruction. A receiver receives instructions from the player. A music player plays music, stops playing music when the player inputs a pause instruction, and restarts playing music when the player inputs a restart instruction. An object display displays object images that indicate the stored game tasks on a screen in pace with the played music, and displays only object images that indicate the game tasks for which the timing has never occurred once since the music began to be played. A score determiner determines the player's score for each of the game tasks based on the stored game tasks and the inputted operation instructions.

### CROSS-REFERENCE TO RELATED APPLICATION

This application claims the benefit of Japanese Patent Application No. 2011-127625, filed on Jun. 7, 2011, the entire disclosure of which is incorporated by reference herein.

### TECHNICAL FIELD

This application relates generally to a game device, a game device control method and an information recording medium, and more particularly, to a game device, a game device control method and an information recording medium suitable for making it possible for a player to smoothly return to a game in the case of a game of which play can be stopped and restarted.

### BACKGROUND ART

In a game that is played within a virtual space, often it is possible for the player to interrupt (temporarily stop) progress of the game and restart the game at arbitrary timing. When a game that has been paused is suddenly restarted, the feeling for the game has become dulled, so that play after the game has been restarted may become disadvantageous for the player. For example, in a music game, when a game is paused at a point where the timing when the player is supposed to give instructions, or the contents of those instructions (hereafter, referred to as a “game tasks”) are close spaced together, it may be difficult to return to the game when the game is restarted.

Therefore, as in the case of the game device disclosed in Unexamined Japanese Patent Application Kokai Publication No. 2010-142270, a game can be restarted from a specified amount of time before the point in time where the game was paused. Moreover, as in the case of the game device disclosed in Unexamined Japanese Patent Application Kokai Publication No. 2010-279577, a game is divided into a plurality of sections, and when the game is temporarily stopped, progress of the game is repeated in units of these sections.

However, when restarting a game, by simply returning the progression of the game to a point before the point of the pause, there is a problem in that it may be difficult for the player to remember up to what point the game was played before the pause, or what the first game task is after restarting the game before arriving at the point of pause, making it difficult to return to the game.

In order to solve this kind of problem, the object of the present invention is to provide a game device, a game device control method and an information recording medium suitable for making it possible for a player to smoothly return to a game in the case of a game of which play can be stopped and restarted.

### SUMMARY

In order to accomplish the object above, the invention is disclosed below according to the principles of the present invention.

The game device according to a first aspect of the present invention comprises a task memory, a receiver, a music player, an object display and a score determiner.

The task memory stores a plurality of game tasks beforehand for indicating the timing when a player is to input an operation instruction.

The receiver receives instructions from the player.

The music player plays music, stops playing music when the player inputs a pause instruction, and restarts playing music from a position in the music before the position where the music was stopped when the player inputs a restart instruction.

The object display displays object images that indicate the stored game tasks on a screen in pace with the played music, and displays only objects for which the timing has never occurred once since the music began to be played.

The score determiner determines the player's score for each of the game tasks based on the stored game tasks and the inputted operation instructions.

The game that is performed by this game device is a game wherein the player (user) can operate an input device (so-called “controller”) and input various instructions. The player, at arbitrary timing, can pause a game, and can restart a paused game. Pausing the game referred to here is not ending the game, but rather is temporarily stopping the progression of the game. For example, when the player desires to take a break while playing a game, by performing a specified operation, progression of the game is paused. After the break is finished, by the player performing a specified operation, the progression of the paused game is restarted.

The instructions that are inputted by the player are operation instructions, a pause instruction and a restart instruction. The operation instructions are, for example, instructions necessary for the progression of the game, such as commands for the game device, commands for characters that appear in the game, instructions for selecting various choices, inputting text, and the like. The pause instruction is an instruction for temporarily stopping the progression of the game. A restart instruction is an instruction for restarting the progression of a temporarily stopped game.

Game tasks that define the timing at which the player is to input operation instructions are prepared for the game beforehand. These prepared game tasks are sequentially presented to the player as the game proceeds. For example, in a dance game wherein the player moves his/her body according to music that is played, the game tasks are presented to the player by displaying object images (hereafter, also referred to as “instruction marks”) on a monitor to indicate whether to move the feet forward, backward to the left or to the right (game tasks).

When the game starts, music begins to be played, and instruction marks that indicate game tasks are displayed in keeping with the music. For example, instruction marks are displayed and scrolled in pace with the speed that the music is played. The player's level (score) of accomplishing the presented game tasks is determined. When a pause instruction is received, the music stops being played, scrolled display of the instruction marks is stopped, and determination of the score is stopped. When the game is paused and a restart instruction is received, the music is restarted, the scrolled display of the instruction marks is restarted, and determination of the score is restarted.

When the game is restarted, in the present invention, the game is restarted from before the time in the game when the game was paused. When the game is restarted after being paused at a certain timing, the music is also restarted from before the position where the music was paused. In other words, when restarting, the music is restarted going back a certain length of time (hereafter, called the “retroactive time”). On the other hand, the instruction marks are not displayed the same as before the pause by simply going back the amount of the retroactive time, but rather, instruction marks that indicate only the game tasks from among all of the game tasks for which the timing has not yet come since the music began to be played before the pause are displayed. In other words, when the game is restarted, instruction marks that indicate game tasks for which the timing for the player to perform an operation already passed before the pause are not displayed, so that only game tasks for which the score has not yet been determined are presented. Therefore, it is easy for the player to know up to what point the game was played before the pause, and to know at a glance from where determination of the score will be restarted. Moreover, after restarting, time is provided for the player to regain a feel for the flow of the game. With the game device of the present invention, the player is able to smoothly return to the game after the game is restarted.

The music may comprise a plurality of bars.

When the restart instruction is inputted from the player, the music player may restart playing music from a specified number of bars of music before the bar that includes the position where the game was paused.

In other words, the music is restarted from a point of good timing for dividing the music. In the present invention, this increases the effect of enabling the player to smoothly return to the game when the game is restarted.

The game device may further comprise a score memory that stores the score determined for the plurality of stored game tasks.

When the restart instruction is inputted from the player, the music player may set the restart position for restarting the music based on the stored score.

In other words, the retroactive time can be set to be long or short depending on the player's score before the game was paused. In the present invention, the effect of enabling the player to smoothly return to the game after being paused is increased by setting the length of the retroactive time to a length that is estimated according to the player's skill for playing the game in order to be long enough for the player to easily return to the game.

The music player may set the time length from the position where the game was paused to the position where the music will be restarted to a shorter length the better the stored score is.

In other words, when the player's score before the game was paused was good, the player can enter the unaccomplished portion of the game right away, and when the player's score before the game was paused was poor, extra time can be provided for entering the unaccomplished portion of the game when restarting. With the present invention, not only is it possible for the player to more smoothly return to the game when restarting the game, but it is also possible to be easy on beginners to the game, as well as satisfy the needs of veteran players.

When the restart instruction is inputted from the player, the music player may set the restart position for playing the music based on the game tasks from among the plurality of stored game tasks that are before the position where the game was paused and/or the game tasks after the position where the game was paused.

In other words, the length of the retroactive time can be set to be long or short depending on the contents of “past” game tasks that were presented and for which the score was already determined before the pause, or the contents of “future” game tasks for which the score has not yet been determined. With the present invention, the effect of enabling the player to smoothly return to the game after restarting is increased by setting the length of the retroactive time to a length that is estimated according to the contents and difficulty of the game before and after the timing when the game was paused to be long enough for the player to easily return to the game.

The music player may set the length of the time from the position where the game was paused to the position where the music is restarted to a longer length the greater the number of game tasks there are from among the plurality of stored game tasks that are before the position where the game was paused and/or that are after the position where the game was paused.

In other words, when the number of “past” game tasks is few, it is possible for the player to enter into the unaccomplished portion of the game right away, and when the number of “past” game tasks is great, extra time can be provided for entering into the unaccomplished portion of the game after restarting. Alternatively, when the number of “future” game tasks is few, it is possible to enter the unaccomplished portion of the game right away, and when the number of “future” game tasks is great, it is possible to provide extra time for entering the unaccomplished portion of the game after restarting. The effect of enabling the player to smoothly return to the game after restarting is increased by setting the length of the retroactive time to a length that is estimated according to the contents and difficulty of the game before and after the timing when the game was paused to be long enough for the player to easily return to the game when restarting the game.

The music player may set the length of the time from the position where the game was paused to the position where the music is restarted to a longer length the less similarity there is among the game tasks of the plurality of stored game tasks that are before the position where the game was paused and/or that are after the position where the game was paused.

In other words, when “past” game tasks are similar to each other, it is estimated that the difficulty of the game is not high, so that it is possible for the player to enter into the unaccomplished portion of the game right away. When “past” game tasks are not similar to each other, it is estimated that the difficulty of the game is high, so that extra time can be provided for entering into the unaccomplished portion of the game after restarting. Alternatively, when “future” game tasks are similar to each other, it is estimated that the difficulty of the game is not high so that it is possible to enter the unaccomplished portion of the game right away. When the “future” game tasks are not similar to each other, it is estimated that the difficulty of the game is high, so that it is possible to provide extra time for entering the unaccomplished portion of the game after restarting. The effect of enabling the player to smoothly return to the game after restarting is increased by setting the length of the retroactive time to a length that is estimated according to the contents and difficulty of the game before and after the timing when the game was paused to be long enough for the player to easily return to the game when restarting the game.

The music may comprise a plurality of bars.

The music player may set the length of the time from the position where the game was paused to the position where the music is restarted to a longer length the greater the number of game tasks of the plurality of store game tasks there are that are set within the bar that includes the position where the game was paused.

In other words, when the number of game tasks that are set in the bar of music where the game was paused is great, it is estimated that the difficulty of the game at the point where the game was paused is high, so that it is possible to provide extra time for entering the unaccomplished portion of the game after restarting. The effect of enabling the player to smoothly return to the game after restarting is increased by setting the length of the retroactive time to a length that is estimated according to the contents and difficulty of the game before and after the timing when the game was paused to be long enough for the player to easily return to the game when restarting the game.

The control method of the game device according to another aspect of the present invention is a control method that is executed by a game device comprising a task memory, a receiver, a music player, an object display and a score determiner, the control method comprising a receiving step, a music playing step, an object display step and a score determination step.

The task memory stores a plurality of game tasks beforehand for indicating the timing when a player is to input an operation instruction.

In the receiving step, the receiver receives an instruction from the player.

In the music playing step, the music player plays music, stops the music when the player inputs a pause instruction and restarts the music from a position in the music before the position where the music was stopped when the player inputs a restart instruction.

In the object display step, the object display displays object images that indicate the stored game tasks on a screen in pace with the played music, and displays only objects for which the timing has never occurred once since the music began to be played.

In the score determination step, the score determiner determines the player's score for each of the game tasks based on the stored game tasks and the inputted operation instructions.

With the game device of the present invention, it is possible for a player to smoothly return to a game when restarting the game.

The non-transitory information recording medium according to another aspect of the present invention stores a program for causing a computer to function as a task memory, a receiver, a music player, an object display and a score determiner.

The task memory stores a plurality of game tasks beforehand for indicating the timing when a player is to input an operation instruction.

The receiver receives an instruction from the player.

The music player plays music, stops playing music when the player inputs a pause instruction, and restarts playing music from a position in the music before the position where the music was stopped when the player inputs a restart instruction.

The object display displays object images that indicate the stored game tasks on a screen in pace with the played music, and displays only objects for which the timing has never occurred once since the music began to be played.

The score determiner determines the player's score for each of the game tasks based on the stored game tasks and the inputted operation instructions.

With the present invention it is possible to allow a computer to function as a game device that operates as described above.

The program of the present invention can be stored on a recording medium that is readable by a computer such as a compact disk, flexible disk, hard disk, magneto optical disk, digital video disk, magnetic tape, semiconductor memory or the like.

The program above can be independent from the computer that executes the program, and can be distributed and/or sold via a computer communication network. Moreover, the information memory medium can be distributed and/or sold independent of the computer.

### BRIEF DESCRIPTION OF THE DRAWINGS

A more complete understanding of this application can be obtained when the following detailed description is considered in conjunction with the following drawings, in which:

FIG. 1 is a drawing illustrating the main construction of a typical information processor for achieving the game device of the present invention;

FIG. 2 is drawing for explaining the construction of a first controller;

FIG. 3 is a drawing for explaining the construction of a second controller;

FIG. 4 is a drawing illustrating an example of a game screen;

FIG. 5 is a drawing for explaining the functional construction of a game device;

FIG. 6A is a drawings for explaining a game screen as a game proceeds;

FIG. 6B is a drawings for explaining a game screen as a game proceeds;

FIG. 7A is a drawings for explaining a game screen as a game proceeds;

FIG. 7B is a drawings for explaining a game screen as a game proceeds;

FIG. 8A is a drawing for explaining processing when a game is paused;

FIG. 8B is a drawing for explaining processing when a game is restarted;

FIG. 9 is a drawing for a game screen when a game is restarted;

FIG. 10 is a drawing for explaining a score judgment process;

FIG. 11 is a flowchart for explaining game processing;

FIG. 12 is a drawing for explaining the functional construction of a game device of a second embodiment;

FIG. 13A is a drawing wherein a player's scores for game tasks are arranged in order of time;

FIG. 13B is a drawing wherein the task times and timing of the pause instruction are arranged in order of time;

FIG. 14 is a drawing illustrating the correlation between a player's score and the retroactive time;

FIG. 15A is a drawings wherein game tasks and timing of pause instructions are arranged in order of time;

FIG. 15B is a drawings wherein game tasks and timing of pause instructions are arranged in order of time;

FIG. 16 is a drawing illustrating the correlation between the total number of extracted game tasks and the retroactive time;

FIG. 17 is a drawing illustrating the correlation between time intervals between extracted game tasks and the retroactive time; and

FIG. 18 is a drawing illustrating the correlation between the similarity between extracted game tasks and the retroactive time.

### DETAILED DESCRIPTION

Embodiments of the present invention will be explained below. In the following, in order to make the invention easier to understand, embodiments for achieving the present invention by using an information processor for a game are explained; however, the embodiments explained below are for explanation purposes and do not limit the scope of the present invention. Therefore, it is possible for one skilled in the art to employ embodiments in which equivalents of some or all of the elements of the embodiments described below are applied, and those embodiments as well are included within the range of the present invention.

### Embodiment 1

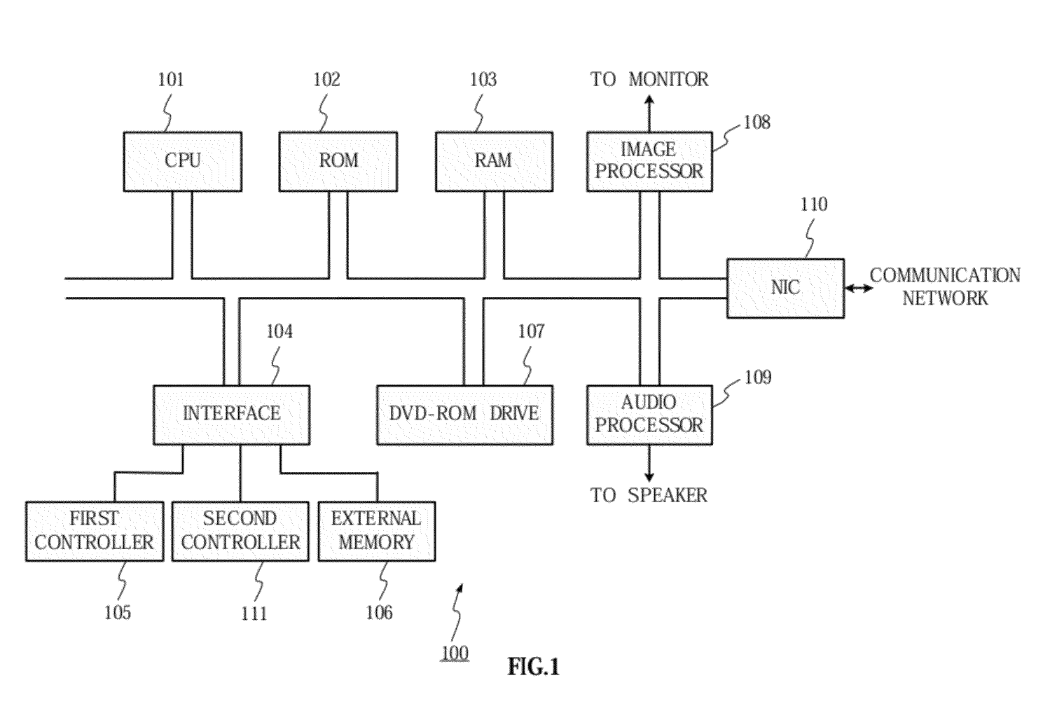

FIG. 1 is a schematic diagram that illustrates the major construction of a typical information processor 100 that, by executing a program, functions as a game device of the embodiments of the present invention.

The information processor 100 comprises a CPU (Central Processing Unit) 101, a ROM (Read Only Memory) 102, a RAM (Random Access Memory) 103, an interface 104, a first controller 105, an external memory 106, a DVD-ROM (Digital Versatile Disc ROM) drive 107, an image processor 108, an audio processor 109, an NIC (Network Interface Card) 110 and a second controller 111.

A DVD-ROM on which a game program and data are stored is mounted in the DVD-ROM drive 107, and by turning ON the power to the information processor 100, the program is executed, and the game device according to this embodiment is achieved.

The CPU 101 controls the overall operation of the information processor 100, is connected with each of the components and exchanges control signals and data with the components. The CPU 101 uses an ALU (Arithmetic Logic Unit) (not illustrated in the figures) on high-speed accessible memory areas called registers (not illustrated in the figures) in order to be able to perform arithmetic operations such as addition, subtraction, multiplication and division, logical operations such as logical OR, logical AND, logical NOT and the like, and bit operations such as bit addition, bit multiplication, bit inversion, bit shift, bit rotation and the like. Furthermore, the CPU 101 may have the construction itself or may comprise a co-processor in order to perform saturate calculations such as addition, subtraction, multiplication and division, or vector calculations such as trigonometric functions in order to handle multimedia processing at high speed.

An IPL (Initial Program Loader) that is executed immediately after the power has been turned ON is stored in ROM 102, and by executing this IPL, the program stored on the DVD-ROM is read into RAM 103, and execution of that program is started by the CPU 101. Moreover, the necessary operating system programs and various kinds of data that are necessary for controlling the overall operation of the information processor 100 are stored in ROM 102.

The RAM 103 temporarily stores data and programs, and stores programs and data that are read from the DVD-ROM, as well as other data that are necessary for progression of the game and for chat communication. Moreover, there is an area in RAM 103 for variables, and the CPU 101 may perform operation by causing the ALU to directly act on the values stored for those variables, or may perform processing by first storing the values stored in RAM 103 in a register, performing operation using the values in the register, and then rewriting the operation results in memory.

The first controller 105 and the second controller 111 that are connected via the interface 104 receive control input that the player inputs while playing the game. The first controller 105 and second controller 111 will be described in detail later. In the explanation below, the first controller 105 may simply be called a “controller”, and the second controller 111 may be called a “mat”.

Data that indicates the game status (past scores and the like), data that indicates the progression status of the game, log (record) data of chat communication in the case of competition over a network and the like are stored such that they are rewritable in a removable external memory 106 that is connected via the interface 104. By inputting instructions via the first controller 105 or second controller 111, the player is able to appropriately store these data in the external memory 106.

Programs for performing the game, and image data and audio data for the game are stored on the DVD-ROM that is mounted in the DVD-ROM drive 107. According to control by the CPU 101, the DVD-ROM drive 107 performs a reading process for reading the mounted DVD-ROM, reads the necessary programs and data and temporarily stores those programs and data in RAM 103.

The image processor 108 processes the data read from the DVD-ROM by way of an image operation processor (not illustrated in the figures) that the CPU 101 or image processor 108 comprises, and stores the results in a frame memory (not illustrated in the figures) that the image processor 108 comprises. The image information that is stored in the frame memory is converted to a video signal at specified synchronization timing, and outputted to a monitor (not illustrated in the figures) that is connected to the image processor 108. As a result, various images can be displayed.

The image operation processor can execute transparent operations such as superimposing or α blending of 2-dimensional images, and can execute various saturation operations at high speed.

In the case where the virtual space is 3-dimensional, the image operation processor can also execute operations for performing rendering using the Z buffer method of polygon information that is located in the 3-dimensional space and to which various kinds of texture information have been added, and obtaining a rendered image of polygons located in virtual space as seen from a specified direction of sight from a specified viewpoint.

Furthermore, by the CPU 101 and the image operation processor working together, it is possible to draw text character strings as 2-dimensional images according to font information that defines the shapes of text characters in the frame memory or on the surfaces of each polygon.

The audio processor 109 converts the audio data that is read from the DVD-ROM to an analog audio signal, and causes this analog audio signal to be output from speakers that are connected to the audio processor 109. According to control from the CPU 101, the audio processor 109 reproduces effect sound and music data that are to be generated during the progress of the game, and causes the sound corresponding to that data to be output from the speakers.

When the audio data that is stored on the DVD-ROM is MIDI data, the audio processor 109 references the source data of that MIDI data, and converts the MIDI data to PCM data. Moreover, in the case where the audio data is compressed audio data such as ADPCM format data or Ogg Vorbis format data, the audio processor 109 expands the data and converts the data to PCM data. PCM data can undergo D/A(Digital/Analog) conversion at timing that corresponds to the sampling timing, and sound can be outputted by outputting the resulting analog signal to the speakers.

Furthermore, it is possible to connect a microphone to the information processor 100. In that case, A/D (Analog/Digital) conversion of the analog signal from the microphone is performed at a suitable sampling frequency, and as a digital signal in PCM format, can undergo processing such as mixing by the audio processor 109.

The NIC 110 is for connecting the information processor 100 to a computer network (not illustrated in the figure) such as the Internet, and comprises a modem according to 10 BASE-T/100 BASE-T standard that is used when building a LAN (Local Area Network), an analog mode for connect to the Internet using a telephone line, an ISDN (Integrated Services Digital Network) modem, an ADSL (Asymmetric Digital Subscriber Line) modem, cable mode for connecting to the Internet using a cable television line, and the like, and an interface (not illustrated in the figure) as an intermediary between these and the CPU 101.

In addition, the information processor 100 can uses a large-capacity memory device such as a hard disk to achieve the same function as the ROM 102, RAM 103, external memory 106 and DVD-ROM that is mounted in the DVD-ROM drive 107.

The information processor 100 explained above corresponds to a so-called “consumer television game device”; however, the present invention can also be achieved by any device that performs image processing for displaying a virtual space. Therefore, it is possible to achieve the present invention on a mobile telephone, portable game device, Karaoke device, typical business computer and various kinds of computers.

For example, as in the information processor 100 described above, a typical computer comprises a CPU, RAM, ROM, DVD-ROM drive, and NIC, and comprises an image processor that has simpler functions than the image processor 100, and in addition to having a hard disk as an external memory device can use a flexible disk, magneto-optical disk, magnetic tape and the like. Moreover, instead of the first controller 105 and second controller 111, it is possible to use an input device such as a keyboard or mouse.

In this embodiment, a controller for which various parameters can be measured, such as the current position and orientation of the controller 105 in actual space, is used as the first controller 105.

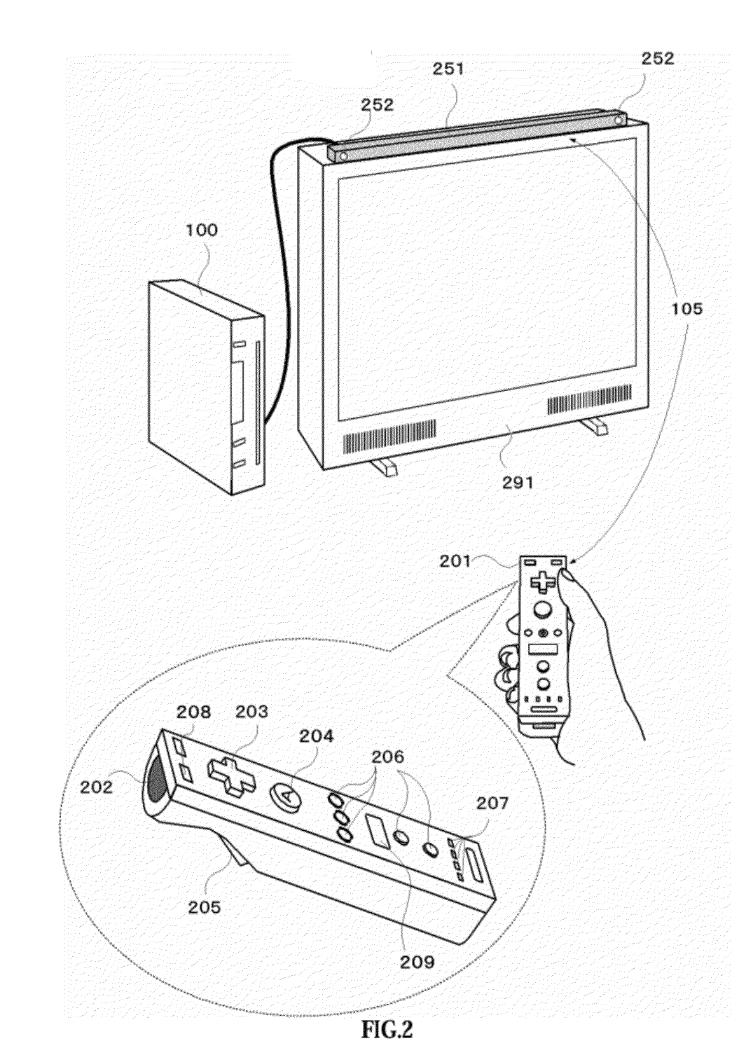

FIG. 2 is a drawing that illustrates the external appearance of the first controller 105, for which various parameters, such as the position and orientation in actual space, can be measured, and the information processor 100. The following explanation will reference FIG. 2.

The first controller 105 is a combination of a grip module 201 and a light-emitting module 251. The grip module 201 is connected so as to be able to communicate with the information processor 100 by wireless communication. The light-emitting module 251 is connected so as to be able to communicate with the information processor 100 by wired communication. The sound and images that are the result of processing by the information processor 100 are output and displayed by a television 291.

The grip module 201 has an external appearance that is similar to that of a remote controller of the television 291, and there is a CCD camera 202 located in the tip end.

On the other hand, the light-emitting module 251 is fastened to the top of the television 291, and light-emitting diodes 252 are located in both ends of the light-emitting module 251; and this light-emitting module 251 emits light according to power that is supplied from the information processor 100.

The CCD camera 202 of the grip module 201 takes images of the state of this light-emitting module 251.

Information of the images taken is sent to the information processor 100, and the CPU 101 of the information processor 100 acquires the position of the grip module 201 with respect to the light-emitting module 251 based on the position of the light-emitting diodes 252 in the image taken by the CCD camera 202.

In addition, there is an acceleration sensor, angular acceleration sensor, inclination sensor and the like built in the grip module 201, so it is possible to measure the orientation of the grip module 201 itself. This measurement result is also sent to the information processor 100.

There is a cross-shaped key 203 on the top surface of the grip module 201, and by pressing and operating this cross-shaped key 203, the player is able to input various direction instructions. Moreover, in addition to an A button 204, there are also various buttons 206 on the top surface, and it is possible to input instructions that correspond to those buttons.

On the other hand, there is a B button 205 that is located on the bottom surface of the grip module 201, and together with a depression that is formed in the bottom surface of the grip module 201, this B button 205 forms a trigger of a gun or magic hand. Typically, instruction input for shooting a gun or holding a magic hand in virtual space is performed using the B button 205.

Moreover, indicators 207 on the top surface of the grip module 201 indicate to the player the operating status of the grip module 201, the wireless communication status with the information processor 100 and the like.

A power button 208 that is prepared on the top surface of the grip module 201 turns ON/OFF the operation of the grip module 201 itself, and operation of the grip module 201 is powered by a built-in battery (not illustrated in the figure).

In addition, a speaker 209 is located on the top surface of the grip module 201, and that speaker 209 outputs sound according to an audio signal that is inputted from the audio processor 109. A vibrator (not illustrated in the figure) is provided inside the grip module 201, and it is possible to control whether or not there is vibration, and the intensity of the vibration based on an instruction from the information processor 100.

In the explanation below, it is presumed that the position and orientation of the grip module 201 in the real world is measured using the first controller 105, which is a combination of the grip module 201 and the light-emitting module 251. However, the case wherein, instead of the form above, the position and orientation of the first controller 105 in the real world is measured using ultrasound or infrared communication, a Global Positioning System (GPS) or the like is also included in the present invention.

A second controller (mat) 111 that is in the shape of a mat can be placed on the floor or the like, and the player can press specified areas on the surface with his/her hands or feet. There are buttons in specified areas on the surface of the second controller 111 that can receive input instructions when pressed by the user, or detection sensors that detect pressure applied by the user can be located in those specified areas.

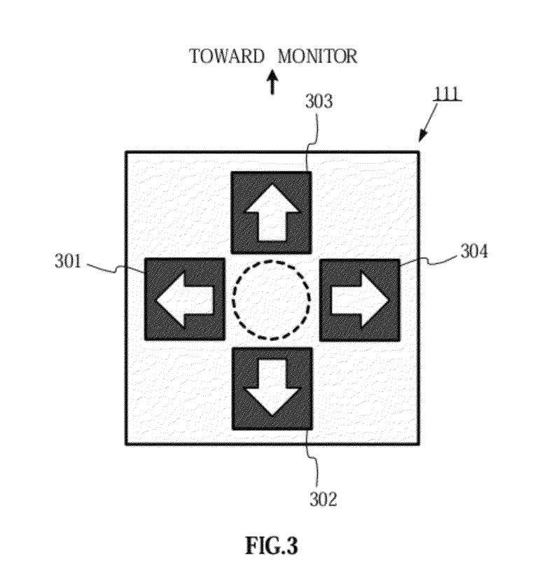

FIG. 3 is a drawing illustrating the second controller 111 that is placed on the floor as seen from directly above. A button 301 that receives input from the player that instructs “Left”, a button 302 that receives input from the player that instructs “Down”, a button 303 that receives input from the player that instructs “Up”, and a button 304 that receives a input from the player that instructs “Right” are located in specified areas of the second controller 111. The player can press the buttons 301 to 304 at arbitrary timing.

The state in which a button 301 to 304 is pressed by the player is called the “Pressed State”, and the state in which a button is not pressed is called the “Non-pressed State”. The CPU 101 determines for each button 301 to 304 whether the button is in the pressed state or non-pressed stated.

The second controller 111 of this embodiment comprises four buttons 301 through 304, however the number of buttons is not limited to four buttons, and there could also be three or less or five or more.

Next, a summary of a game that is executed by the information processor 100 will be explained.

FIG. 4 is an example of the configuration of a game screen that is displayed on the monitor. On the game screen, there are stationary marks 401 through 404 that are drawn at specified fixed positions inside the screen, there are instruction marks 410 (there are four kinds in the figure, 410A, 410B, 410C and 410D) that are drawn at positions that move as time elapses, there are bar lines 420 (in the figure there are lines 420A, 420B and 420C) that indicate divisions of musical bars of a song being played, there is a gage 430 that displays the player's score, and there are other background images. The bar lines 420 are usually spaced uniformly; however, the length between certain music bars, and the length between other music bars may be different. The instruction marks 410, as will be described later, may also be fixed inside the screen. The instruction marks 410 may also be called “Object Images”.

The instruction marks 410 and bar lines 420 are scrolled to correspond to the music being played. In this embodiment, Up, Down Left and Right arrows are drawn for the instruction marks 410. The instruction marks 410 indicate the timing at which the player is supposed to move in the direction of the drawn arrows, or in other words represent the game tasks.

For example, the instruction marks 410 indicate the timing at which the player is supposed to press the buttons 301 through 304 that correspond to the drawn arrows. Typically, the player steps on the buttons 301 through 304 with his/her feet. In this case, the instruction marks 410 are also called “step position instruction marks” or “Foot Notes”.

Alternatively, for example, the instruction marks 410 indicate the timing at which the grip module 201 is to be waved in the direction corresponding to direction of the drawn arrows. In this case, the instruction marks 410 are also called “wave position instruction marks” or “Hand Notes”.

The stationary marks 401 through 404 indicate the timing at which the player is supposed to press the buttons 301 through 304 (hereafter, also referred to as the “task time”). In this embodiment, images of Up, Down, Left and Right arrows are drawn for the stationary marks 401 through 404.

The instruction marks move toward the position where the stationary marks 401 through 404 are drawn in time with the speed that the music is played. When the instruction marks 410 move to the same positions as the stationary marks 401 through 404, and the player presses the button from among the buttons 301 through 304 that corresponds to the direction of the arrow that is drawn in the stationary mark 401 through 404, a specified number of points are added to the player's score, and the value displayed by the gage 430 (dance meter) is increased.

As an instruction mark 410 moves to a position that overlaps one of the stationary marks 401 through 404, and the player steps on the button (one of the buttons 301 through 304) that corresponds to the instruction mark 410 that has moved, the player steps on model dance steps the correspond to the music that is played, and enjoys the game with a feeling of dancing.

After an instruction marks 410 has overlapped one of the stationary marks 401 through 404, that instruction mark 410 continues moving in the same direction and eventually disappears from the screen. It is also possible for the CPU 101 to cause an instruction mark 410 that corresponds to a game task for which the player's score has been determined to disappear from the screen at the instant that the player's score was determined, or after a specified amount of time after the player's score was determined.

A game task in this embodiment is represented by a combination of information that specifies a task time and a button that is supposed to be pressed at that task time. One game task is expressed as in Equation 1.

P(i)=(T(i), B(x)) Equation 1

It is presumed that there are N number (N is an integer 1 or greater) of game tasks in the game of the present invention, and P(i) represents the i-th (“i” is an integer that not less than 1 and not greater than N) game task from the start. T(i) represents the task time that corresponds to the game task P(i). B(x) represents the type of operation that the player is supposed to perform (hereafter, referred to as the “task contents”).

When the instruction mark 410 is a “Foot Note”, a value B(L) that indicates that the player is supposed to press the button 301, a value B(D) that indicates that the player is supposed to press the button 302, a value B(U) that indicates that the player is supposed to press the button 303, or a value B(R) that indicates that the player is supposed to press the button 304 is specified as the task contents B(x).

When the instruction mark 410 is a “Hand Note”, H(L) that indicates that the player is supposed to wave the grip module 201 to the left, H(D) that indicates that the player is supposed to wave the grip module 201 down, H(U) that indicates that the player is supposed to wave the grip module 201 up, or H(R) that indicates that the player is supposed to wave the grip module 201 to the right is specified as the task contents B(x).

For example, it is presumed that a certain game task is expressed as in Equation 2.

P(i)=(T(i), B(L)) Equation 2

Here, the i-th game task of the game is “the player is to press the left button 301 on the second controller 111 at task time T(i)”. Normally, the player should step on the left button 301 when the time during the game reaches the task time T(i).

For example, it is presumed that a certain game task is expressed as in Equation 3.

P(i)=(T(i), H(R)) Equation 3

Here, the i-th game task of the game is “the player is supposed to wave the grip module 201 to the right at task time T(i)”. The player should wave the hand holding the grip module 201 to the right side when the time during the game reaches the task time T(i).

It is also possible to correlate a plurality of task contents to one task time. However, preferably only a maximum of two task contents are correlated with one task time. For example, when two task contents B(x1), B(x2) are correlated with the task time T(i), the game task is expressed as in Equation 4.

P(i)=(T(i), B(x1), B(x2)) Equation 4

Alternatively, the game task can be expressed as two different game tasks as in Equation 5 and Equation 6.

P(i)=(T(i), B(x1)) Equation 5

P(i+1)=(T(i), B(x2)) Equation 6

For example, it is presumed that a certain game task is expressed as in Equation 7.

P(i)=(T(i), B(L), B(R)) Equation 7

Here, the i-th game task of the game is “the player is to press the left button 301 of the second controller 111 and press the right button 304 of the second controller 111 at task time T(i)”, When the game time reaches time T(i), the player should step on both the left button 301 and right button 304.

The CPU 101 determines the player's score for each game task based on how close to the task time the button from among the buttons 301 through 304 that is indicated by the task contents is pressed. For example, when a button that is indicated by the task contents is pressed at timing that is the same as the task time, the CPU 101 determines that the score is “PERFECT”, and when the button that is indicated by the task contents is pressed at timing that is within a specified range before or after the task time, the CPU 101 determines that the score is “GOOD”, and when the button is not pressed or is pressed at another timing, the CPU 101 determines that the score is “BAD”.

Alternatively, the CPU 101 can determine the player's score for each game task based on whether or not the button from among the buttons 301 through 304 that is indicated by the task contents is pressed. \The initial data that indicates a game task is stored beforehand on a DVD-ROM or in an external memory 106. However, game tasks can be added or updated later by the CPU 101.

In this embodiment, a game task is defined by correlating task contents to a task time; however, a game task can also be defined as just a task time. For example, in a game that uses only one of the buttons 201 through 204, or in a game where any one of the buttons can be pressed according to the rhythm of the music being played, the game task can be expressed for just the task time as illustrated by Equation 8.

P(i)=(T(i)) Equation 8

The number of game tasks that can be set for one song is not especially limited. The CPU 101 or the game creator can arbitrarily define the task time and task contents for the game tasks. The game tasks can be defined beforehand as fixed game tasks before the game starts, or can be changed, added or deleted by the CPU 101 according to advancement of the game, elapsed time in the virtual world of the game, elapsed time in the real world, player's score the song being played, or the like.

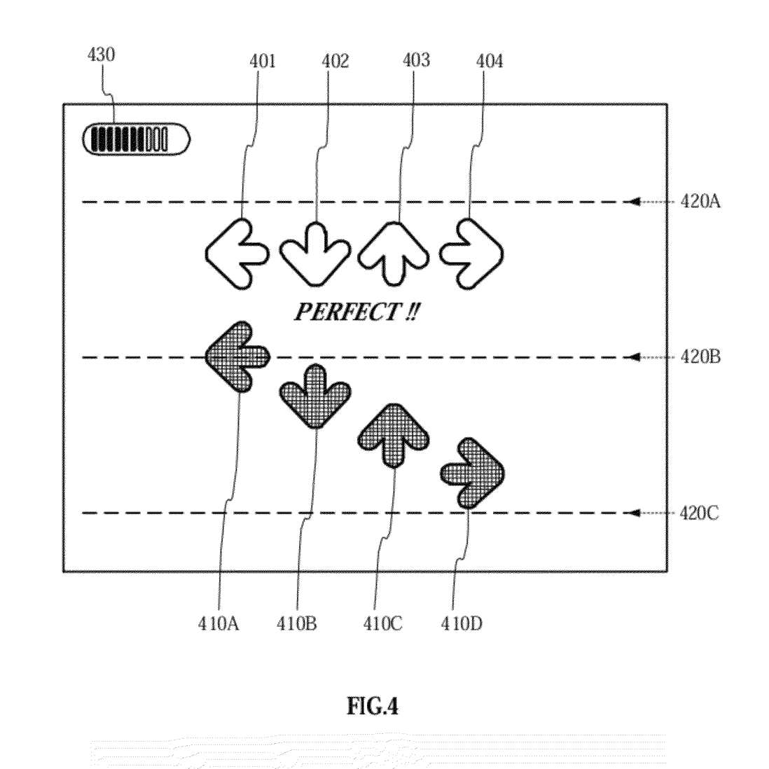

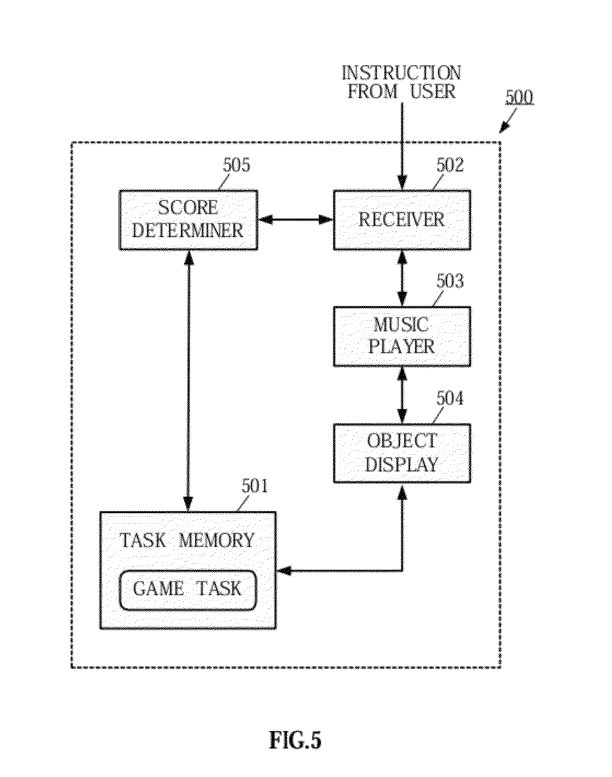

Next, the functional construction of the game device 500 of this embodiment that is achieved by the information processor 100 having the construction above is explained. FIG. 5 illustrates the functional construction of the game device 500. The game device 500 comprises a task memory 501, a receiver 502, a music player 503, an object display 504 and a score determiner 505.

The task memory 501 stores the game tasks described above that indicate the timing during the game at which the player is supposed to input an operation instruction. Typically, information that defines a plurality of game tasks is stored beforehand on a DVD-ROM, and the CPU 101 controls a DVD-ROM drive 107 in order to read the information that defines the game tasks from the DVD-ROM drive 107, and stores that information in RAM 103. The CPU 101 uses the information stored in RAM 103 that defines the game tasks for determining the display of instruction marks 410 and the player's score. The CPU 101, together with the RAM 103, functions as the task memory 501.

The receiver 502 receives various instructions related to the game from the player. Together, the CPU 101 and the controller 105 function as the receiver 502.

In the game performed by the game device 500 of the present invention, the player can interrupt (temporarily stop) the progress of the game at arbitrary timing, and can restart the progress of a paused game at arbitrary timing. When the game is in progress, music is played, game tasks are sequentially presented to the player, and the player's score is determined for each of the game tasks that are presented. On the other hand, when the game is paused, the music stops playing, game tasks are not presented to the player, and the player's scored is not determined.

Instructions that are received include operation instruction, a pause instruction, and a restart instruction. After the game has been started, the player inputs these instructions by operating the first controller 105 or second controller 111. However, operation instructions and the pause instruction are only received when the game is not paused, and the restart instruction is received only when the game is paused.

When the instruction marks 410 are “Foot Notes”, the operation instruction is (a) an instruction instructing the left direction by pressing the button 301, (b) an instruction instructing the down direction by pressing the button 302, (c) an instruction instructing the up direction by pressing button 303, or (d) an instruction instructing the right direction by pressing the button 304.

Alternatively, when the instruction marks 410 are “Hand Notes”, the operation instruction is either (e) an instruction instructing the left direction by waving the grip module 201 to the left, (f) an instruction instructing the down direction by waving the grip module 201 downward, (g) an instruction instructing the up direction by waving the grip module 201 upward, or (h) an instruction instructing the right direction by waving the grip module 201 to the right.

The pause instruction is an instruction for pausing the game that is in progress. After receiving the pause instruction, the CPU 101 fixes the instruction marks 410 that are being scrolled at the position they were displayed at when the pause instruction was received. The CPU 101 also stops playing the music and determining the player's score. For example, by inputting the pause instruction when the player wants to take a break, the player is able to temporarily stop advancement of the game.

The restart instruction is an instruction for restarting a game that has been paused. After the restart instruction has been received, the CPU 101 returns the display positions of instruction marks, which were fixed at display positions and that correspond to game tasks for which the task time had not yet reached the time in the game before the pause instruction occurred, a certain amount of time (referred to as the “retroactive time”). When the game is restarted, instruction marks that correspond to game tasks for which the task time had already reached the time in the game before the interrupt occurred (game tasks for which the score has already been determined) are not displayed. After that, the CPU 101 once again causes the instruction marks 410 and bar lines 420 to scroll over time toward the positions of the stationary marks 401 through 404. Moreover, the CPU 101 starts playing the music in step with the scrolled display of the instruction marks 410 from the point of time before the retroactive time. The game is restarted from the point in time before the interrupt by the amount of the retroactive time. However, game tasks that were already finished during this retroactive time are not displayed on the screen in order that those game tasks are not scored again.

When restarting the game, in order that the player can prepare for smoothly returning to the game and can remember the contents of the game before the interrupt, the progression of the game is delayed the amount of the retroactive time. The length of the retroactive time is arbitrary. The CPU 101 can set the length of the retroactive time as a number of seconds or a number of times that a VSYNC occurs or the like, or can set the length of the retroactive time in units of bars of music played. The game is restarted from a little before the paused scene, so that the player can easily return to the game.

Moreover, when restarting the game, the CPU 101 can restart the game from the start of the bar of music in which the interrupt timing is included, or from the start of the bar of music one before (or two or more before) the bar of music in which the interrupt timing is included. As a result, the game is restarted from a point before the paused scene and from a portion that is at a good breaking point in the music, so that it is even easier for the player to return to the game.

Next, the music player 503 reads music data that is stored beforehand on a DVD-ROM or in an external memory 106, decodes the read music data, and plays the music. The sound of the played music is outputted from a speaker. Together, the CPU 101and the audio processor 109 function as the music player 503.

As described above, playing of the music may be stopped and restarted as the game is paused or restarted. More specifically, when a game starts, the CPU 101 starts playing the music. When a player inputs the pause instruction, the CPU 101 stops playing the music. Moreover, when the player inputs the restart instruction, the CPU 101 starts playing the music again from an amount of time equal to the retroactive time before where the music was stopped.

The object display 504 displays instruction marks, which indicate the game tasks stored in the task memory 501 and that are instruction marks that indicate the game tasks for which the game time from when the music player 503 started playing the music has never reached the task time, on the screen in step with the music being played. Together, the CPU 101 and the image processor 108 function as the object display 504.

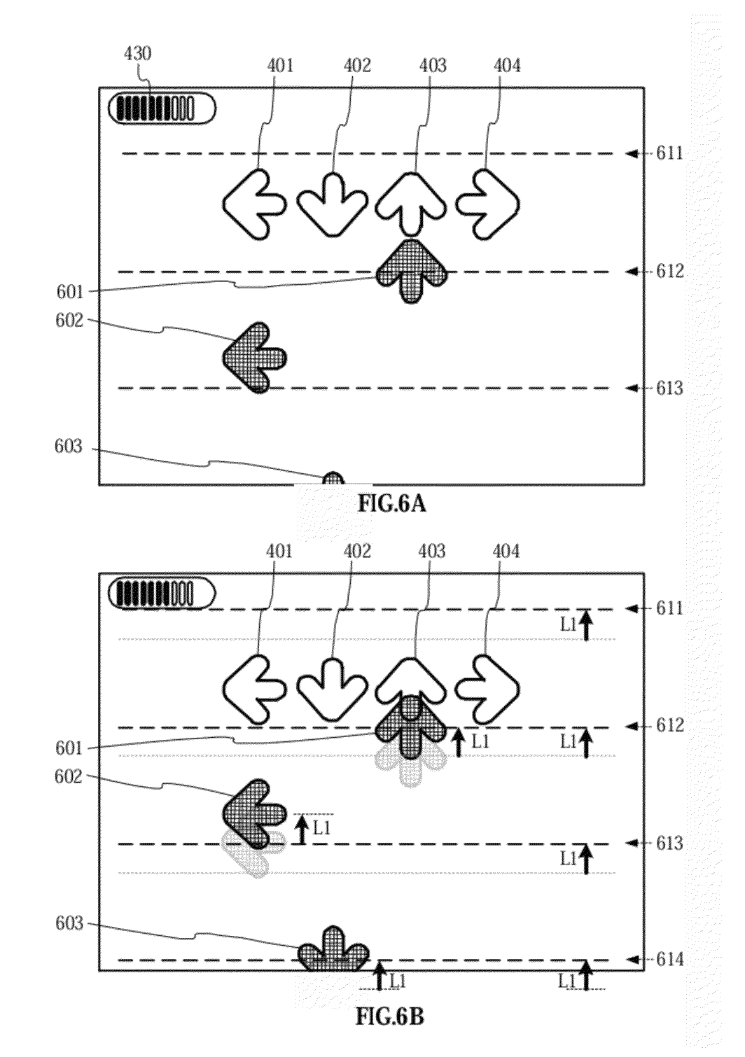

FIG. 6A illustrates an example of the configuration of a game screen when a game is in progress (game is not paused). In FIG. 6A, in addition to stationary marks 401 through 404, there are also instruction marks 601, 602, 603 that indicate game tasks, and bar lines 611, 612, 613. However, the CPU 101 can omit the display of the bar lines 611, 612, 613. When the game is not paused, the player is able to input operation instructions and a pause instruction.

The instruction marks 601, 602, 603 and bar lines 611, 612, 613 move together from the bottom of the screen toward the top, keeping with the music. The game task corresponding to instruction mark 601 is that “the player is to press the button 303 indicating the Up direction when the instruction mark 601 becomes superimposed over the stationary mark 403”. The game task corresponding to instruction mark 602 is that “the player is to press the button 301 indicating the Left direction when the instruction mark 602 becomes superimposed over the stationary mark 401”. The game task corresponding to instruction mark 603 is that “the player is to press the button 302 indicating the Down direction when the instruction mark 603 becomes superimposed over the stationary mark 402”.

FIG. 6B is a game screen after an amount of time T1 has elapsed from the time in the game when the game screen illustrated in FIG. 6A was displayed. The instruction marks 601, 602, 603 and the bar lines 611, 612, 613 have all moved a distance L1 that corresponds to the elapsed time T1. Also a new bar line 614 appears.

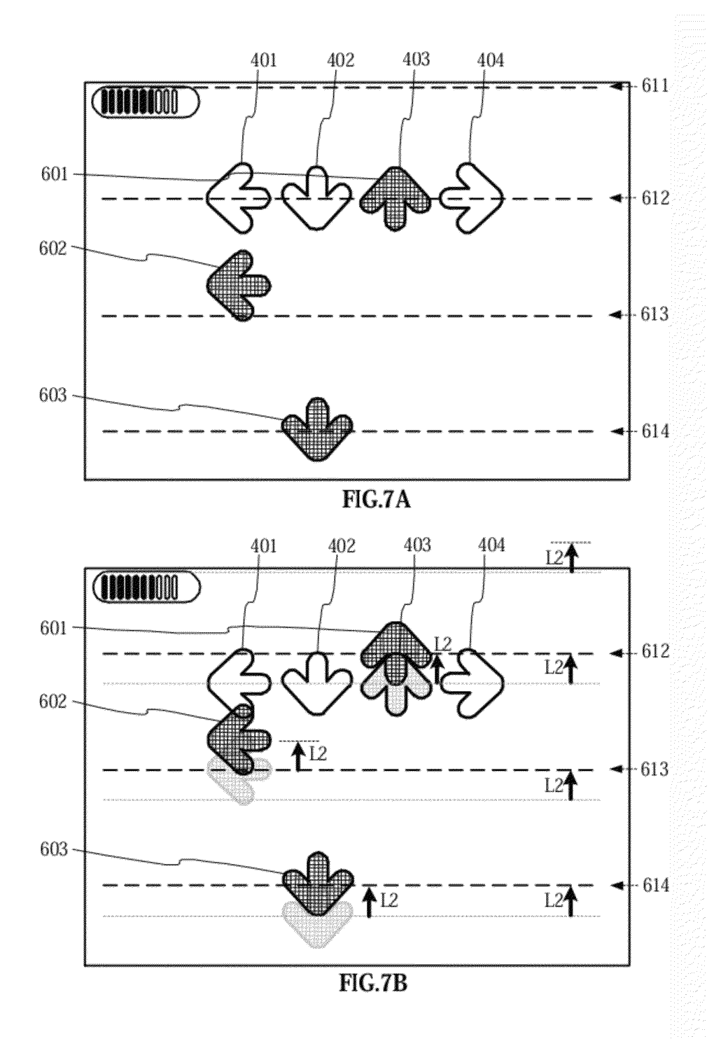

Furthermore, as time elapses, the instruction mark 601 becomes superimposed over the stationary mark 403 as illustrated in FIG. 7A. In the case where the player presses the button 303 at this timing (in other words, the operation instruction indicating the Up direction is inputted), the CPU 101 determines that the score for the game task corresponding to the instruction mark 601 was “Excellent”. On the other hand, in the case where the player presses the button 303 at a time in the game before the instruction mark 601 has become superimposed over the stationary mark 403, the CPU 101 determines that the score for the game task corresponding to the instruction mark 601 is “Not Good” or “The Timing is Too Early”. In the case where the player presses the button 303 at a time in the game after the instruction mark 601 was superimposed over the stationary mark 403, the CPU 101 determines that the determines that the score for the game task corresponding to the instruction mark 601 is “Not Good” or “The Timing is Too Late”.

Furthermore, as time elapses, the instruction mark 601 and bar lines 611, 612 move beyond the stationary mark 403, the bar line 611 disappears, the instruction mark 602 and bar line 613 approach the stationary mark 401, and the instruction mark 603 and bar line 614 approach the stationary mark 402 as illustrated in FIG. 7B.

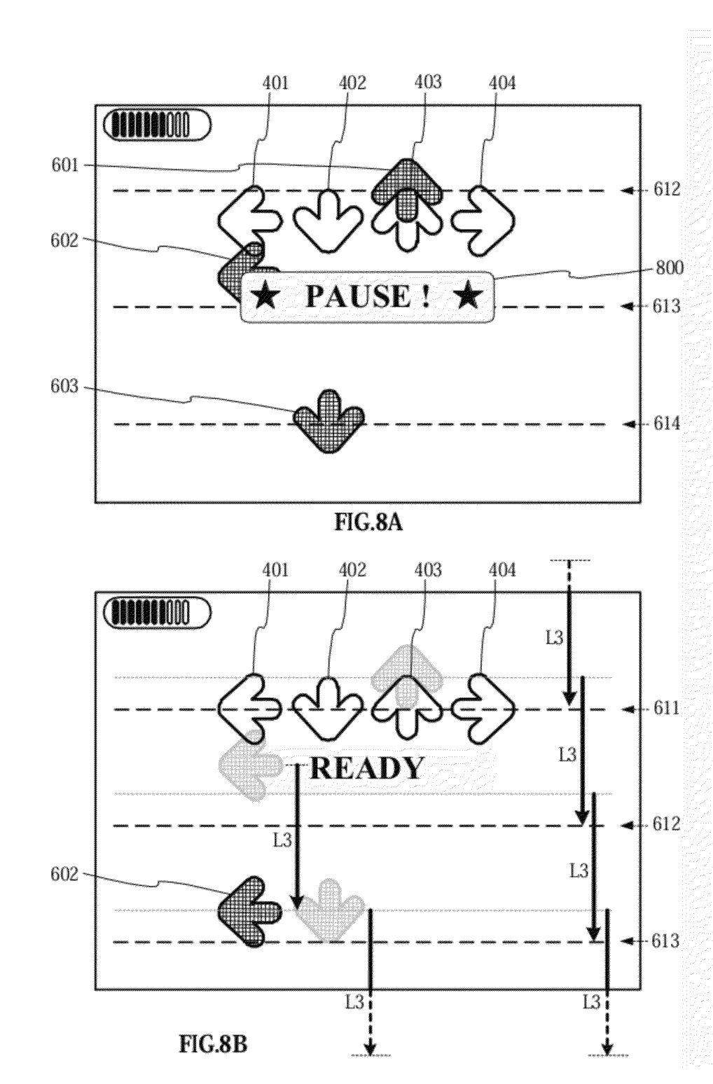

As illustrated in FIG. 8A, when the pause instruction is received at that point, the CPU 101 stops the movement of the instruction marks 601, 602, 603 and bar lines 612, 613, 614, stops the playing of music, and displays a message 800 indicating that the game has been paused. The contents of the message 800 can be freely changed as long as the message indicates that the game is paused. While the game is paused the player can only input a restart instruction and cannot input the operation instruction or the pause instruction.

As illustrated in FIG. 8B, when the restart instruction is received after the game has been paused, the CPU 101 returns the display position of the instruction marks 602, 603 and the bar lines 611, 612, 613, 614 a distance L2. In the example, the size of the distance L2 corresponds to the retroactive time described above, or in other words, corresponds to the time length between (x) the time in the game at which the pause instruction was received, and (y) the time in the game at the start of the bar line one before the bar line that includes the time in the game at which the pause instruction was received.

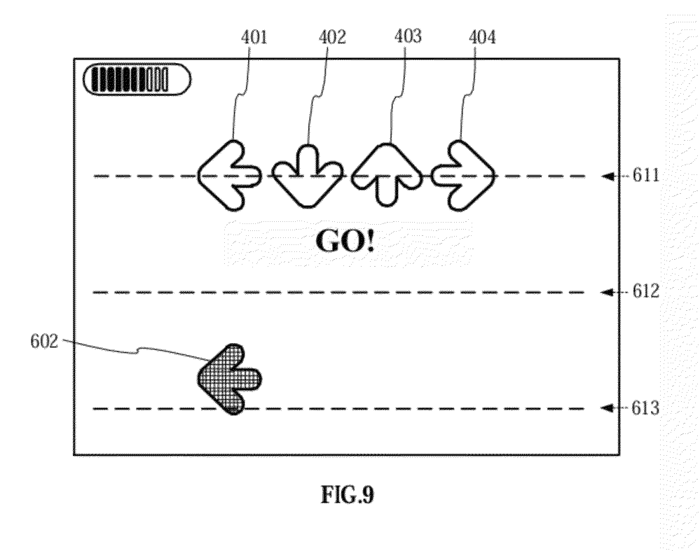

As a result, as illustrated in FIG. 9, the game screen when the game is restarted returns to the retroactive time to the game screen before when the pause instruction was received, and the instruction mark 601 that indicates a game task for which the task time as already passed is not displayed. The CPU 101 displays and scrolls the instruction mark 602 and the bar lines 611, 612, 613 in step with the music. After the game has restarted, game tasks are sequentially presented to the player from the start of the bar line one before the bar line that included the timing of the pause. Moreover, the CPU 101 returns to the retroactive time and starts playing the music again.

Instruction marks 601 that indicate game tasks for which the time in the game after the music is started had already reached the task time before the pause are not displayed after the game is restarted. In other words, the game screen is not simply returned a certain amount of time, and only the instruction marks that indicate game tasks for which a score has not been determined are displayed.

The CPU 101 may restart the scroll display of the instruction mark 602 and the like, and playing of the music immediately after the restart instruction is received, or can also restart the scroll display of the instruction mark 602 and the like, and playing of the music after a certain amount of time has elapsed after the restart instruction has been received. In other words, it is possible to provide a “mental preparation period” for returning to the game for a specified amount of time after the player inputs the restart instruction.

Next, the score determiner 505 determines the player's score for game tasks based on the game tasks stored in the task memory 501 and operation instructions inputted by the player. When a total of N number of game tasks have been set, the score determiner 505 determines the player's score for each of the N number of game tasks. Alternatively, the score determiner 505 determines the player's score for each of the game tasks that are included in the set game tasks from the time that the game starts to the time in the game when the game ends. Together, the CPU 101, the RAM 103, the first controller 105 and the second controller 111 function as the score determiner 505.

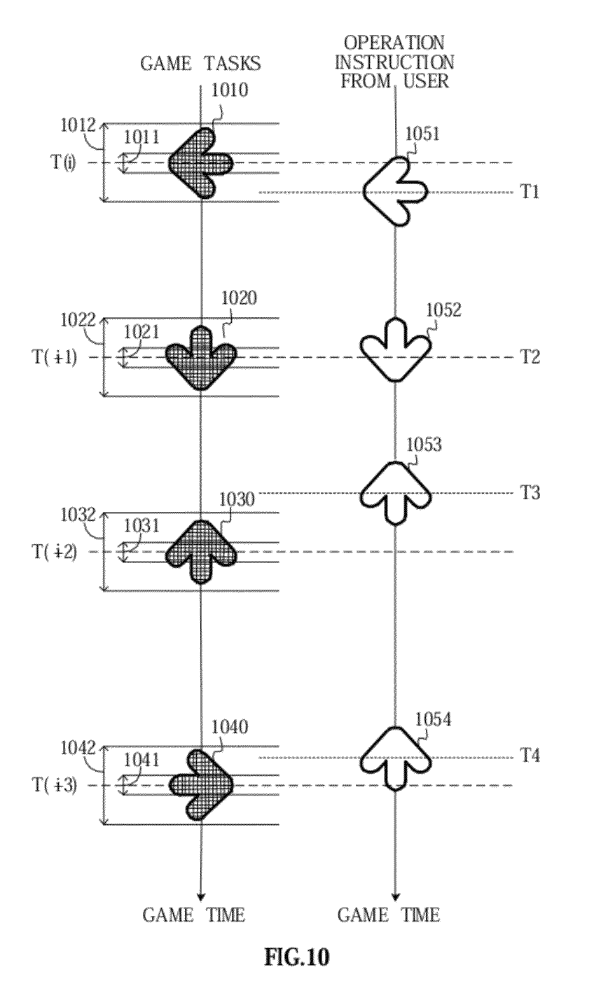

The score determination process that is performed by the game device 500 will be explained in detail using FIG. 10, which schematically illustrates an example of the set game tasks and the operation by the player.

Game task 1010 indicates that “the player is to press the button 301 that indicates the Left direction at task time T(i)”. Alternatively, the game task 1010 indicates that “the player is to wave the grip module 201 toward the left side at task time T(i)”.

Game task 1020 indicates that “the player is to press the button 302 that indicates the Down direction at task time T(i+1)”. Alternatively, the game task 1020 indicates that “the player is to wave the grip module 201 downward (toward the ground) at task time T(i+1)”.

Game task 1030 indicates that “the player is to press the button 303 that indicates the Up direction at task time T(i+2)”. Alternatively, the game task 1030 indicates that “the player is to wave the grip module 201 upward (opposite the ground) at task time T(i+2)”.

Game task 1040 indicates that “the player is to press the button 304 that indicates the Right direction at task time T(i+3)”. Alternatively, the game task 1040 indicates that “the player is to wave the grip module 201 toward the right side at task time T(i+3)”.

A time interval for the CPU 101 to determine the score is set for each game task. The score is determined based on whether or not the timing of an operation by the player is within this time interval.

In this embodiment, for the game task 1010, the CPU 101 sets an interval 1011 that indicates that the time is within a first specified amount of time before or after the task time T(i), and an interval 1012 that indicates that the time is within a second specified amount of time before or after the task time T(i). These two time intervals 1011, 1012 are used in determining the score.

More specifically, when the CPU 101 determines that an operation that is the same as the task contents is performed by the player at the same time as the task time T(i), the CPU 101 determines that the player's score for the game task 1010 is “PERFECT”.

Moreover, when the CPU 101 determines that an operation that is the same as the task contents is performed by the player at a time that is different than the task time T(i) but within the time interval 1011, the CPU 101 determines that the player's score for the game task 1010 is “GREAT”.

When the CPU 101 determines that an operation that is the same as the task contents is performed by the player at a time that is not within the time interval 1011 but is within the time interval 1012, the CPU 101 determines that the player's score for the game task 1010 is “GOOD”.

Furthermore, when the CPU 101 determines that an operation that is the same as the task contents is not performed by the player at a time that is within the time interval 1012, the CPU 101 determines that the player's score for the game task 1010 is “BAD”.

When multiple operations are received within the time interval 1012 that indicates that the time is within the second specified time (or the time interval 1011 that indicates that the time is within the first specified), the CPU 101 handles the operation of the received operations that is received at the earliest time as the operation instruction for the game task 1010.

Similarly, for the game tasks 1020, 1030 and 1040, the CPU 101 sets time intervals 1021, 1031 and 1041 that indicate time within a first specified time, and time intervals 1022, 1032 and 1042 that indicate time with a second specified time, and determines the score.

When determining the player's score for a certain game task, first, the CPU 101 determines whether or not any operations performed by the player are within an interval that indicates the time is within the second specified time for that game task. When it is determined that no operations were performed within that time interval, the CPU 101 determines that the score for that game task is “BAD”.

When it is determined that some operations are performed, the CPU 101 acquires the game time and the instruction content of the operation instruction that is received the nearest to the task time of that game task.

For example, in FIG. 10, of the operation instructions 1051 through 1054 performed by the player, the operation whose time is the closest to the task time T(i) of the game task 1010 is the operation 1051. Therefore, the CPU 101 determines that the player performed the operation instruction 1051 for the game task 1010.

The operation instruction 1051 indicates that “the player pressed the button 301 indicating the Left direction at time T1”. The time T1 at which the operation instruction 1051 was performed is included in the time interval 1012; however, is not included in the time interval 1011, and the contents of the operation instruction 1051 (press the Left button 301) matches the task contents (pressed the left button 301), so the CPU 101 determines that the player's score for the game task 1010 is “GOOD”.

Moreover, of the operation instructions 1051 through 1054 that are performed by the player, the one that is closest to the task time T(i+1) of the game task 1020 is operation 1052. Therefore, the CPU 101 determines that the player performed operation instruction 1052 for game task 1020.

The operation instruction 1052 indicates that “the player pressed the button 302 indicating the Down direction at time T2”. The time T2 at which the operation instruction 1052 was performed coincides with the task time T(i+1), and the contents of the operation instruction 1052 (press the Down button 302) matches the task contents (pressed the Down button 302), so that the CPU 101 determines that the player's score for the game task 1020 is “PERFECT”.

Of the operation instructions 1051 through 1054 that are performed by the player, the one that is closest to the task time T(i+2) of the game task 1030 is operation 1053. Therefore, the CPU 101 determines that the player performed operation instruction 1053 for game task 1030.

The operation instruction 1053 indicates that “the player pressed the button 303 indicating the Up direction at time T3”. The time T3 at which the operation instruction 1053 was is not included in the time interval 1032, so the CPU 101 determines that the player's score for the game task 1030 is “BAD”.

Moreover, of the operation instructions 1051 through 1054 that are performed by the player, the one that is closest to the task time T(i+3) of the game task 1040 is operation 1054. Therefore, the CPU 101 determines that the player performed operation instruction 1054 for game task 1040.

The operation instruction 1054 indicates that “the player pressed the button 303 indicating the Up direction at time T4”. The time T4 at which the operation instruction 1054 is included within the time interval 1042 but not within the time interval 1041, and the contents of the operation instruction 1054 (press the Right button 304) does not match the task contents (pressed the Up button 303), so that the CPU 101 determines that the player's score for the game task 1040 is “BAD”.

The task contents and the contents of the operation instruction performed by the player, instead of being that “the player is to press one of the buttons 301 through 304” can be to “wave the grip module 201 Up, Down, Left or Right”.

In this embodiment, the CPU 101 distinguishes the level of the match between the game task and the operation performed by the player in four levels, “PERFECT”, “GREAT”, “GOOD” and “BAD”, however determining the level of match is not limited to this. For example, there could be three levels of match or less, or there could be five levels or more. The CPU 101 can also arbitrarily change the length of the time intervals 1011, 1012 used to distinguish the level of match.

When a plurality of operation instructions is performed during the time interval 1012 that indicate that the time is with a second specified time, the operation instruction that is performed first among these operation instructions is used for determining the score.

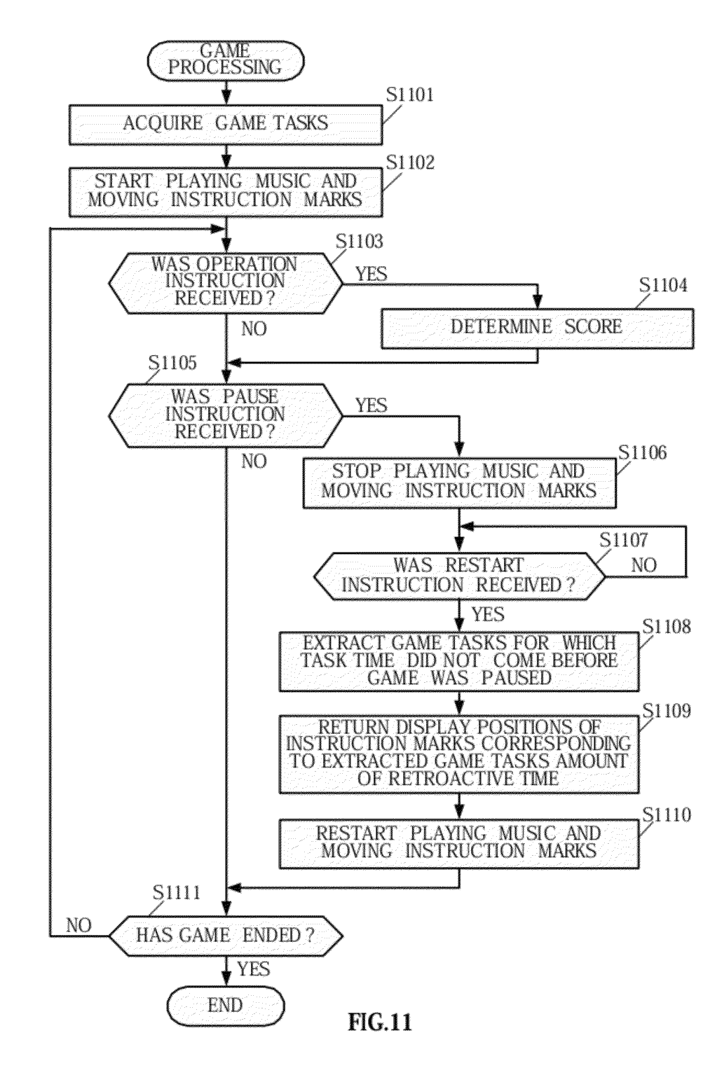

Next, game processing that is performed by a game device 500 having the construction above will be explained using the flowchart in FIG. 11. In this embodiment, the game device 500 performs the dance game described above. The player uses the first controller 105 to input the operation instruction, and uses the second controller 111 to input the stop instruction or the restart instruction. In this embodiment, the instruction marks that are displayed are “Foot Notes”.

It is not illustrated in the flowchart, however, of the operation instruction, the pause instruction and the restart instruction, the CPU 101 can receive operation instructions and the pause instruction when the game is not paused, and can only receive the restart instruction when the game is paused.

First, the CPU 101 acquires music data for the music to be played from DVD-ROM and the like, and also from DVD-ROM or the like, acquires information that defines game tasks that are correlated beforehand with the music to be played (step S1101).

The CPU 101 then starts the game. The CPU 101 starts playing the music, displays instruction marks that indicate the game tasks on the screen and starts moving the instruction marks (step S1102). In this embodiment, the CPU 101 displays and scrolls instruction marks and bar lines in step with the music that is played.

The CPU 101 determines whether or not an operation instruction has been received (step S1103). When it is determined that an operation instruction has not been received (step S1103: NO), the CPU 101 proceeds to the processing of step S1105 that will be described later. On the other hand, when it is determined that an operation instruction has been received (step S1103: YES), the CPU 101 determines the player's score by performing the score determination process described above based on the information defining the game tasks that was acquired in step S1101 and the operation input that was received (step S1104).

Next, the CPU 101 determines whether or not the pause instruction has been received (step S1105). The player can input the pause instruction at arbitrary timing by pressing a specified button on the grip module 201 for example.

When it is determined that the pause instruction has not been received (step S1105: NO), the CPU 101 proceeds to the processing of step 51111 that will be described later. However, when it is determined that the pause instruction has been received (step S1105: YES), the CPU 101 stops playing the music and stops moving the instruction marks (step S1106). In other words, the dance music stops, and the instruction marks that moved together with the music that was played stop. Progression of the game is temporarily stopped and determination of the score is not performed.

The CPU 101 determines whether or not the restart instruction has been received (step S1107). The player can input the restart instruction at arbitrary timing while the game is paused by pressing a specified button on the grip module 201, for example.

When it is determined that the restart instruction has not been received (step S1107: NO), the CPU 101 waits for a restart instruction to be input. In other words, the game remains paused. On the other hand, when it is determined that the restart instruction has been received (step S1107: YES), the CPU 101 extracts the game tasks from among all the game tasks that were acquired in step S1101 for which the task time never occurred once from the time that the music began playing (from when the game was first started) until the game was paused (step S1108).

For example, when the game is paused in the situation illustrated in FIG. 8A as described above, the game task indicated by the instruction mark 601 has already passed the task time, however, the game tasks that are indicated by the instruction marks 602 and 603 have not yet passed the task times. The CPU 101 extracts the two game tasks indicated by instruction mark 602 and instruction mark 603 from among the game tasks indicated by the instruction marks 601, 602 and 603.

Furthermore, the CPU 101 returns the display position for the instruction marks corresponding to the game tasks extracted in step S1108 the set retroactive time (step S1109). For example, when the length of the retroactive time is the “difference between (x), the time when the game was paused, and (y), the time at the start of one bar line before the bar line that includes the time when the game was paused, the CPU 101, as illustrated in FIG. 8B as described above, shifts the instruction marks 602 and 603 and the bar lines 611 through 614 downward a distance L3 that corresponds to the retroactive time.

The CPU 101 returns the position for restarting the music to just before the retroactive time. In other words, for the entire music, there is an interval in the interval played before the pause and in the interval to be played after the pause that overlaps by just the amount of the retroactive time. However, in this overlapping interval, the score is not determined twice for the same game task.

The CPU 101 restarts playing the music from the retroactive time before the position of the music when the game was paused, and restarts the scrolled display of the instruction marks from a distance that corresponds to the retroactive time before the display position when the game was paused (step S1110). In other words, the game is restarted from just before the retroactive time; however, instruction marks that correspond to game tasks for which the task time had already passed before the pause are not displayed on the game screen after restarting.

The CPU 101 determines whether or not the game has ended (step S1111). For example, when the value displayed by the gage 430 becomes a specified value or less (typically, zero or less), or when the game has reached the very end of the music, the CPU 101 determines that the game has ended.

When it is determined that the game has not ended (step S1111: NO), the CPU 101 returns to the processing of step S1103 above, and the game continues. However, when it is determined that the game has ended (step S1111: YES), the CPU 101 end the game process.

With the game device 500 of this embodiment, in a game wherein it is possible to pause and restart play, the player is able to smoothly return to play when restarting a paused game. For example, when the player stops the game in order to take a break, progression of the game is paused at the timing when the stop button was pressed. After that, when the player presses the restart button in order to continue playing the game, the game time returns to a time a little before the time where the game was paused. The player is able to “review” the game for the amount the game has gone back in time. In this embodiment, the game is not just restarted retroactively, but, of the set game tasks, only the game tasks for which the task time did not occur even once before the game was paused are presented to the player. In other words, game tasks for which the score has already been determined are not presented to the player again. Therefore, the player is able to know right away where the game was paused and from where the player must seriously return to playing the game.

### Embodiment 2

Next, another embodiment of the present invention will be explained. In the embodiment described above, the retroactive time was set to a specified length, or was determined based on the divisions of bars of music, however, in this embodiment, the retroactive time is set based on the score of the player that was found from the game tasks and operation instructions.

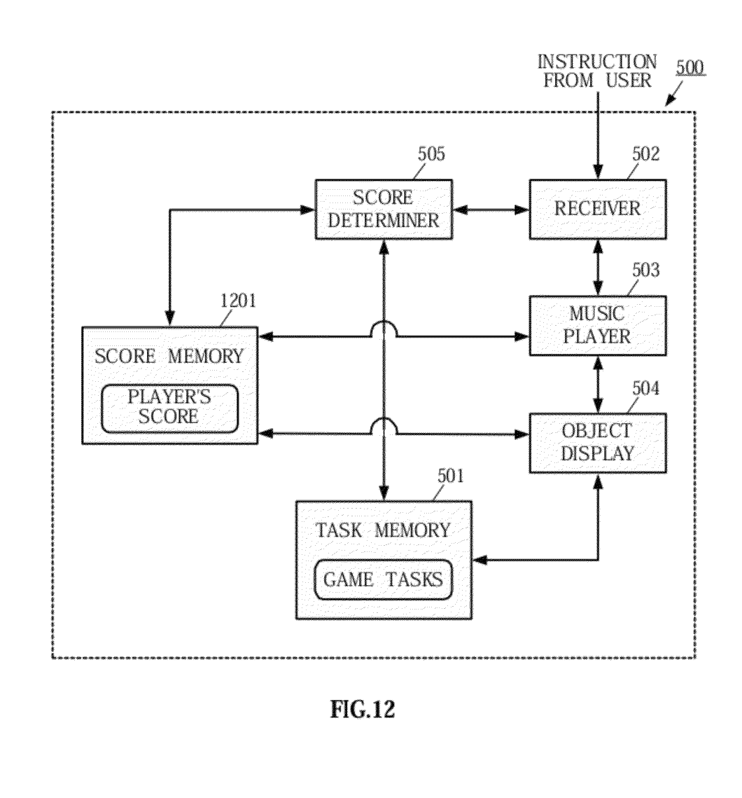

FIG. 12 is a drawing illustrating the functional construction of the game device 500 of this embodiment. This game device 500 further comprises a score memory 1201.

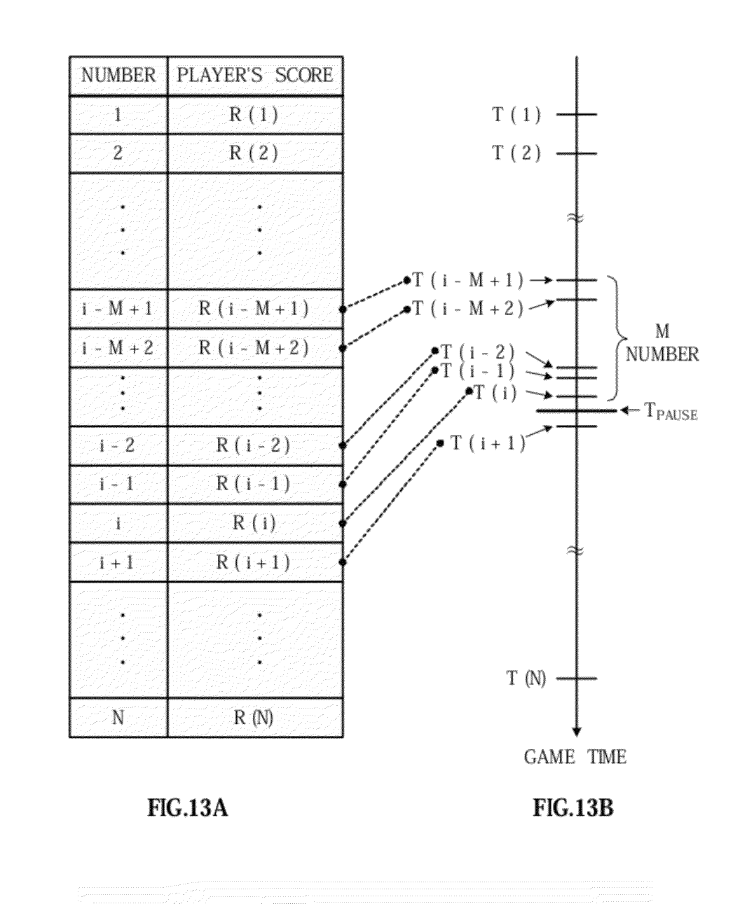

FIG. 13A is a drawing illustrating an example of the data that indicates the score, and that is stored in the score memory 1201. FIG. 13B is a drawing illustrating the time sequence of task times for the set game tasks.

When the CPU 101 receives an operation instruction from the player, the CPU 101 compares the game task (task time and task contents) with the received operation instruction (time in the game and instruction contents) and determines the player's score. The CPU 101 stores information indicating the determined score in RAM 103. The CPU 101 determines the score for each set game task, and as illustrated in FIG. 13A, stores the determined results as the score history in RAM 103. Together, the CPU 101 and the RAM 103 function as the score memory 1201.

When a total of N (N is an integer 1 or greater) number of game tasks is set for a certain piece of music, the CPU 101defines an array variable R having N number of elements as illustrated in Equation 9 before the game starts. The data indicating the score for the i-th (“i” is an integer not less than 1 and not greater than N) game task P(i) is stored in R(i).

R={R(1), R(2), . . . , R(i), . . . , R(N)} Equation 9

As explained in the embodiment described above, the CPU 101 determines the score for one game task P(i) according to the contents of the inputted operation instruction in 5 levels; “PERFECT”, “GOOD”, “AVERAGE”, “POOR” and “BAD”. The CPU 101 then stores a numerical value that indicates the determined result for the variable R(i). A value indicating no score is stored for the values of elements of a variable R corresponding to a game task for which the score has not yet been determined. However, the method for determining the score is not limited by the invention.

The CPU 101, after receiving a stop instruction, stops the progression of the game and waits for the restart instruction to be inputted. After the restart instruction has been inputted, the CPU 101 finds the retroactive time based on the variable R that indicates the score and that is stored in RAM 103.

More specifically, as illustrated in FIG. 13B, the CPU 101 acquires a specified number (M number were M is an integer 1 or greater) of the elements of the variable R whose task times are before the time in the game T_{PAUSE} when the stop instruction was received, in the order of being close to the time in the game T_{PAUSE} when the stop instruction was received. In other words, the CPU 101 acquires M number of elements from among the N number of elements from R(i) corresponding to T(i) to R(i−M+1) corresponding to T(i−M+1). The acquired values indicate the player's scores for M number of game tasks immediately before the game was paused.

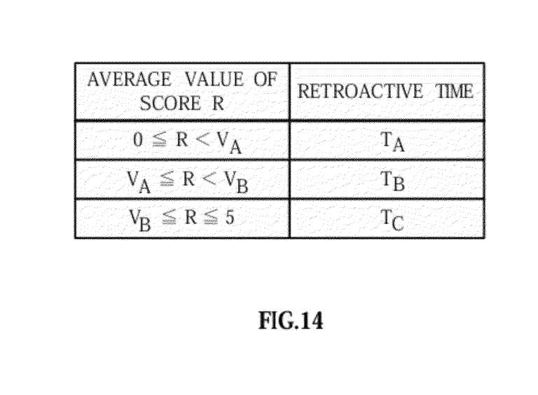

The CPU 101 finds the retroactive time based on the scores of the most recent M number of game tasks. As illustrated in FIG. 14, the CPU 101 calculates the average score and sets the retroactive time according to the calculated average value. When the value “5” is set when the score for the i-th game task P(i) is “PERFECT”, the value “4” is set when the score is “GOOD”, the value “3” is set when the score is “AVERAGE”, the value “2” is set when the score is “POOR”, the value “1” is set when the score is “BAD”, and the value “0” is set when the score has not been determined, the range for determining the average score is from 0 to 5. The CPU 101 divides the range for taking the average value of the score into divisions, and correlates a retroactive time for each division. For example, the CPU 101 uses the retroactive time TA when the average value is 0 or greater but less than VA, uses the retroactive time TB when the average time is VA or greater but less then VB, and used the retroactive time TC when the average value is VB or greater but not greater than 5.

Here, the larger the calculated average value is, or in other words, the better the average score is, the CPU 101 sets the retroactive time to a shorter time. In other words, in FIG. 14, TC<TB<TA. The worse the average score is, the time that the player can “Review” before seriously playing the game becomes longer. The better the average score is, the shorter the time becomes from when the music is restarted until determination of the score restarts. The play of the game can be continued in a comparatively short period of time.

Here, the retroactive time is determined by dividing the average score into three levels, however, the number of levels, the length of each division, and the length of the corresponding retroactive times can be set arbitrarily.

Instead of the average value of the score, the CPU 101 can used various statistical values such as the variance, the standard deviation, the central value, the maximum value, the minimum value of the score or the like.

The CPU 101 uses the retroactive time that was found based on the score to set the position for restarting the music when restarting the game, and the position for displaying the instruction marks when restarting the game. The CPU 101 then restarts playing the music from the set restart position, and restarts the scrolled display of the instruction marks from the set position. Restarting the music and restarting the scrolled display are performed at the same time.

With the game device 500 of this embodiment, when the game is restarted, the player is able to smoothly return to the game according to the player's skill When the player of the game is a beginner, there is a tendency for much time being required for the player to gain back the feel for the game, for example recalling up to what point the game was played to before pausing, what kind of music was played, what kind of game tasks where performed and the like, so by making the retroactive time long, there is an advantage in that it becomes easier to continue with the game. When the player of the game is an advanced player, there is a tendency that the player will have played the dance game with the same music many times and has a good feel for the game, so by making the retroactive time short, there is an advantage in that the player can begin the game very quickly.

In the dance game of this embodiment, the player's score is found by an addition method, and the higher the score (value set for the array variable R) acquired by the player is, or the greater the value indicated by the gage 430 is, the better the player's score is. However, in the case where the player's score for the game performed using the game device 500 is found by a subtraction method, the player's score can be considered to be better the smaller the score acquired by the player is.

Moreover, the value indicating the player's score can be the player's score according to an addition method, a value indicated by the gage 430, the player's score according to a subtraction method, as well as could be, the player's rank during a certain period of time, win-loss rate, number of wins and losses, and the like. For example, in a competition game among a plurality of players, or a competition game between a player character that is operated by one player and a character (NPC: Non Playable Character) that is controlled by the game device, the CPU 101 can determine the length of the retroactive time by calculating the player's or character's rank, win-loss rate, number of wins and losses and the like and setting the retroactive time according to that calculated rank or the like.

### Embodiment 3

Next, another embodiment of the present invention will be explained. In the embodiments above, a specified length was set for the retroactive time, or the length of the retroactive time was set according to the player's score, however, in this embodiment, the CPU 101 determines the length of the retroactive time based on the specific contents of the game before and after the game is paused.

After receiving a restart instruction, the CPU 101 finds the retroactive time based on the game tasks stored in RAM 103 that occurred before the time in the game when the pause occurred, and determines the restart position for playing the music and the restart position for displaying the instruction marks.

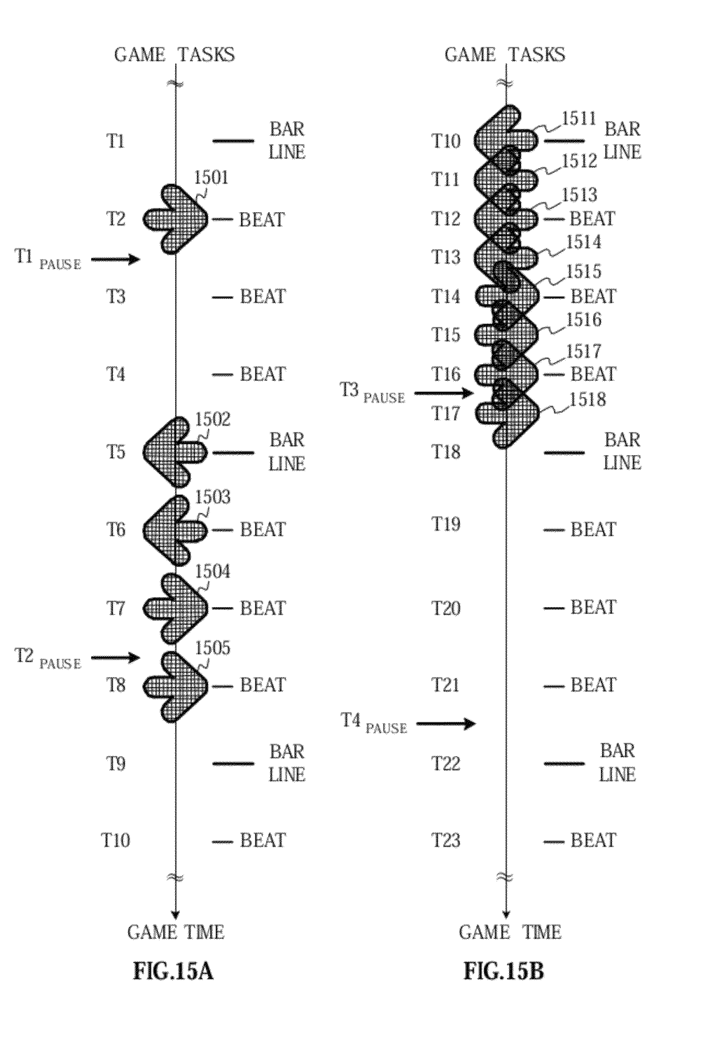

FIGS. 15A and 15B illustrate an example wherein the task times of set game tasks, and the time in the game when progression of the game was paused are sequentially arranged in order of time. In this example, there are four beats per one bar of music, or in other words, the rhythm of the played music is in 4/4 time. In FIG. 15A, one game task is set for the first bar (range of T1≦T<T5), and four game tasks are set for the second bar (range of T5≦T<T9). In FIG. 15B, eight game tasks are set for the first bar (range of T10≦T<T18), and no game task is set for the second bar (range of T18≦T<T23).

In this embodiment, the CPU 101 extracts game tasks that occurred before the time in the game when the pause instruction was received and that are within the bar that includes the time in the game when the pause instruction was received. The greater the total number of extracted game tasks is, the longer the CPU 101 sets the retroactive time. The greater the total number of extracted game tasks is, the higher the CPU 101 estimates the level of difficulty of the game just before the game is paused, so makes it easier for the player to return to the game after being restarted by making the retroactive time longer.

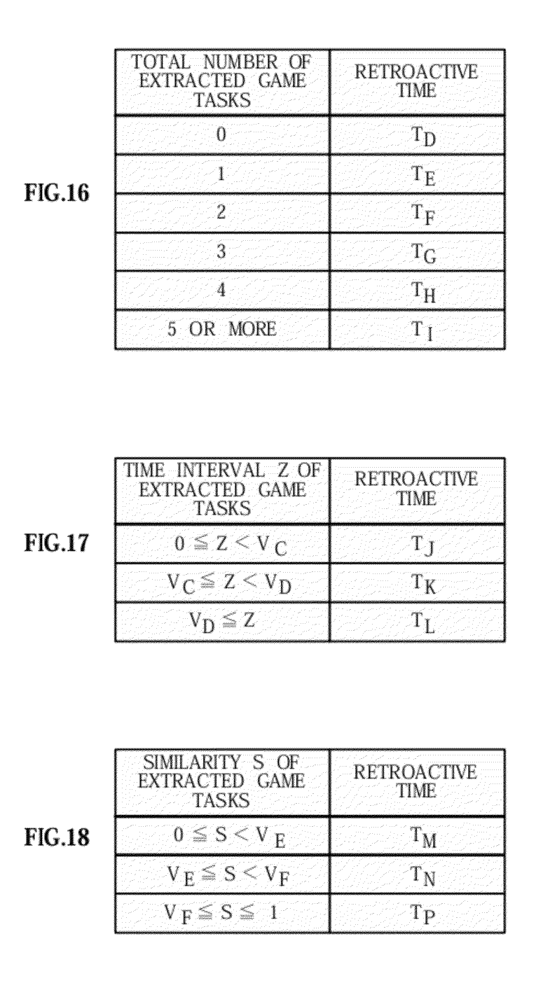

FIG. 16 illustrates an example of the correlation between the total number of extracted game tasks and the retroactive time. The relationship of the size of each value is TD≧TE≧TF≧TG≧TH≧TI. However, this is only an example, and the method for defining the correlation is arbitrary.

For example, when a pause instruction is received at the game time T1_{PAUSE} illustrated in FIG. 15A, the CPU 101 extracts game task 1501 that is included in the range before T1_{PAUSE}, which is the bar that includes T1_{PAUSE} (after T1 and before T5). When the number of extracted game tasks is one, the CPU 101 sets the correlated retroactive time TE. After a restart instruction is received, the playing of music is restarted from just before the retroactive time, however, the instruction mark that indicates the game task 1501, for which the task time already occurred before the pause, is not displayed on the screen.

For example, when the pause instruction is received at the game time T2_{PAUSE} illustrated in FIG. 15A, the CPU 101 extracts game tasks 1502, 1503 and 1504 that are included in the range before T2_{PAUSE}, which is the bar that includes T2_{PAUSE} (after T5 and before T9). When the number of extracted game tasks is three, the CPU 101 sets the correlated retroactive time TG. After the restart instruction is received, the playing of music is restarted from just before the retroactive time; however, the instruction marks that indicate the game tasks 1501 through 1504 for which the task times already occurred before the pause, are not displayed on the screen, but the game task 1505 for which the task time has not yet occurred is displayed on the screen.

For example, when a pause instruction is received at the game time T3_{PAUSE} illustrated in FIG. 15B, the CPU 101 extracts game tasks 1511 through 1517 that are included in the range before T3_{PAUSE}, which is the bar that includes T3_{PAUSE} (after T10 and before T18). When the number of extracted game tasks is seven, the CPU 101 sets the correlated retroactive time TI. After the restart instruction is received, the playing of music is restarted from just before the retroactive time, however, the instruction marks that indicate the game tasks 1511 through 1517 for which the task times already occurred before the pause, are not displayed on the screen, but the game task 1518 for which the task time has not yet occurred is displayed on the screen.

In other words, the greater the number of game tasks there is for which the score was determined immediately before the game was paused, the CPU 101 determines that the level of difficulty when the game was paused was high, so sets the “warming up” time for the player before the score is determined again to a longer time.

The values for TD, TE, TF, TG, TH and TI can each be fixed values or can be changed. For example, when the pause instruction was received at timing such as T1_{PAUSE} when a comparatively small number of game tasks are extracted, the CPU 101 can restart the game from the start of the bar during which the pause instruction was received, or when the pause instruction was received at timing such as T3_{PAUSE} when a comparatively large number of game tasks were extracted, the CPU 101 can restart the game from the start of the bar one before (or two or more bars before) the bar during which the pause instruction was received. In this case, the length of the retroactive time differs depending on the timing at which the game was paused. By increasing the number of bars to go back the greater the number of extracted game tasks is, the game device 500 can make it easier for the player to return to the game according to the level of difficulty of the game.

In this embodiment, when there is not even one game task in the bar that includes the game time at which the pause instruction was received, and that is a game task before the game time at which the pause instruction was received, such as game time T4_{PAUSE} illustrated in FIG. 15B, the CPU 101 restarts the game from the start of the bar in which the pause instruction was received, or in other words, restarts the game from the game time T18. Even when there are no set game tasks, there is no portion for which the music is not played.

The method for setting the retroactive time is not limited to this. When the restart instruction is received, the CPU 101 can find the retroactive time based on the game tasks from among the plurality of game tasks stored in RAM 103 that are “after” the time in the game at which the game was paused, and set the restart position for playing the music.

For example, when the pause instruction was received at the game time T1_{PAUSE} illustrated in FIG. 15A, the CPU 101 extracts the game tasks in the bar that includes T1_{PAUSE} (T1 or later and before T5) and that are included in the range after T1_{PAUSE}. In this case, the total number of extracted game tasks is zero. When the number of game tasks extracted is zero, the CPU 101 sets the correlated retroactive time TD. When the restart instruction is received, the music is restarted from just before the set retroactive time, however, an instruction mark that indicates game task 1501, for which the task time already came before the game was paused, is not displayed on the screen.

For example, when the pause instruction was received at the game time T2_{PAUSE} illustrated in FIG. 15A, the CPU 101 extracts the game task 1505 in the bar that includes T2_{PAUSE} (T5 or later and before T9) and that is included in the range after T2_{PAUSE}. When the number of game tasks extracted is one, the CPU 101 sets the correlated retroactive time TE. When the restart instruction is received, the music is restarted from just before the set retroactive time, however, instruction marks that indicate game tasks 1501 through 1504, for which the task times already came before the game was paused, are not displayed on the screen, but, the instruction mark for game task 1505, for which the task time has not yet occurred, is displayed on the screen.

For example, when the pause instruction was received at the game time T3_{PAUSE} illustrated in FIG. 15B, the CPU 101 extracts the game task 1518 in the bar that includes T3_{PAUSE} (T10 or later and before T18) and that is included in the range after T3_{PAUSE}. When the number of game tasks extracted is one, the CPU 101 sets the correlated retroactive time TE. In other words, at timing T2_{PAUSE} and T3_{PAUSE}, the retroactive time is the same. When the restart instruction is received, the music is restarted from just before the set retroactive time, however, instruction marks that indicate game tasks 1511 through 1517, for which the task times already came before the game was paused, are not displayed on the screen, but, the instruction mark for game task 1518, for which the task time has not yet occurred, is displayed on the screen.

Even when the retroactive time is set based on the game tasks after the time in the game at which the pause instruction was received, it is possible to set the restart position for playing the music in bar units.

Furthermore, when a restart instruction is received, the CPU 101 can find the retroactive time based on both the game tasks from among the plurality of game tasks stored in RAM 103 that are before the time in the game when the game was paused, and the game tasks after the time in the game when the game was paused, and set the restart position for playing the music.

For example, when the pause instruction was received at the game time T1_{PAUSE} illustrated in FIG. 15A, the CPU 101 extracts the game task 1501 in the bar that includes T1_{PAUSE} (T1 or later and before T5). When the number of game tasks extracted is one, the CPU 101 sets the correlated retroactive time TE. When the restart instruction is received, the music is restarted from just before the set retroactive time, however, an instruction mark that indicates game task 1501, for which the task time already came before the game was paused, is not displayed on the screen.

For example, when the pause instruction was received at the game time T2_{PAUSE} illustrated in FIG. 15A, the CPU 101 extracts the game tasks 1502 through 1505 in the bar that includes T2_{PAUSE} (T5 or later and before T9). When the number of game tasks extracted is four, the CPU 101 sets the correlated retroactive time TH. When the restart instruction is received, the music is restarted from just before the set retroactive time, however, instruction marks that indicate game tasks 1501 through 1504, for which the task times already came before the game was paused, are not displayed on the screen, but the instruction mark for game task 1505, for which the task time has not yet occurred, is displayed on the screen.

For example, when the pause instruction was received at the game time T3_{PAUSE} illustrated in FIG. 15B, the CPU 101 extracts the game tasks 1511 through 1518 in the bar that includes T3_{PAUSE} (T10 or later and before T18). When the number of game tasks extracted is eight, the CPU 101 sets the correlated retroactive time TI. When the restart instruction is received, the music is restarted from just before the set retroactive time, however, instruction marks that indicate game tasks 1511 through 1517, for which the task times already came before the game was paused, are not displayed on the screen, but the instruction mark for game task 1518, for which the task time has not yet occurred, is displayed on the screen.

The range in which the game tasks are extracted, does not need to be within the bar that includes that time at which the pause instruction was received, and could be X (X is an integer 1 or greater) number of bars before and after (or just before or just after) the bar that includes the time at which the pause instruction was received

Instead of the total number of extracted game tasks, or in addition to the total number of extracted game tasks, the CPU 101 can set the retroactive time in consideration of the task times and/or task contents of the extracted game tasks.

For example, as illustrated in FIG. 17, the CPU 101 can set the retroactive time according to the time interval S between task times of the extracted game tasks. The shorter the time interval S is, the CPU 101 estimates that the level of difficulty of the game at the point where the game was paused is high. The CPU 101 can set the retroactive time to be longer the higher the level of difficulty is.

When the number of extracted game tasks is one or zero, the CPU 101 handles the time interval as S=0, and when the number of extracted game tasks is three or more, the CPU 101 finds the time respective interval between two adjacent game tasks and uses the average value of the time intervals found. The example in FIG. 17 is only an example, and the method for determining the correlation between the time interval S and the retroactive time is arbitrary even in the case of setting the retroactive time using the time interval S between game tasks instead of using the total number of game tasks.

As illustrated in FIG. 18, the CPU 101 can set the retroactive time according to the similarity in extracted game tasks. For example, when the task contents of two adjacent game tasks that are extracted are the same, the CPU 101 determines that both are similar (similarity Z=1), and when they are different, the CPU 101 determines that they are not similar (similarity Z=0). When the number of extracted game tasks is one or zero, the similarity is taken to be Z=1, and when three or more game tasks are extracted, the similarity between each set of two adjacent game tasks is found, and the average value of the found similarities is used. The example illustrated in FIG. 18 is only an example, and the method for finding the correlation between the similarity Z and the retroactive time is arbitrary.

With this embodiment, the game device 500 can make it possible for the player to smoothly return to the game when the game is restarted in accordance to the development of the game or the level of difficulty. Supposing that that retroactive time were set without taking into consideration of the number of game task or game contents before and after the game is paused, there is a possibility that when restarting a game that had been paused at a point in the game where there was a large concentration of game tasks, the player may not be able to keep up with the game. However, by setting the retroactive time to be longer in cases where there is a large concentration of game tasks or when difficult operation is required, there is an advantage in that it becomes easier for the player to return to the game.

A program for causing a computer to operate as part or all of the game device 500 above can be stored on a recording medium that is readable by a computer such as a memory card, CD-ROM, DVD, MO (Magneto Optical disk) and distributed, and that program can be installed on a different computer, causing the computer to operate as the components of the game device described above, or to execute the processes described above.

Furthermore, the program can be stored on a disk device of a server on the Internet, then superimposed on a carrier wave and downloaded to a computer.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. A device comprising:
a task memory wherein a plurality of tasks are stored beforehand for indicating the timing when a player is to input an operation instruction;
a receiver that receives instructions from the player;
a music player that plays music, stops playing music when the player inputs a pause instruction, and restarts playing music from a position in the music before the position where the music was stopped when the player inputs a restart instruction;
an object display that displays object images that indicate the stored tasks on a screen in pace with the played music, and displays only object images that indicate the tasks for which the timing has never occurred once since the music began to be played; and
a score determiner that determines the player's score for each of the tasks based on the stored game tasks and the inputted operation instructions.

2. The device according to claim 1; wherein
the music comprises a plurality of bars; and
when the restart instruction is inputted from the player, the music player restarts playing music from a specified number of bars of music before the bar that includes the position where a game was paused.

3. The device according to claim 1, further comprising:
a score memory that stores the score determined for the plurality of stored tasks; wherein
when the restart instruction is inputted from the user, the music player sets the restart position for restarting the music based on the stored score.

4. The device according to claim 3, wherein
the music player sets the time length from the position where the was paused to the position where the music will be restarted to a shorter length the better the stored score is.

5. The device according to claim 1, wherein
when the restart instruction is inputted from the player, the music player sets the restart position for playing the music based on the tasks from among the plurality of stored tasks that are before the position where a game was paused and/or the tasks after the position where the game was paused.

6. The device according to claim 5, wherein
the music player sets the length of the time from the position where the game was paused to the position where the music is restarted to a longer length the greater the number of game tasks there are from among the plurality of stored game tasks that are before the position where the game was paused and/or that are after the position where the game was paused.

7. The device according to claim 5, wherein
the music player sets the length of the time from the position where the was paused to the position where the music is restarted to a longer length the less similarity there is among the tasks of the plurality of stored tasks that are before the position where the game was paused and/or that are after the position where the game was paused.

8. The device according to claim 1, wherein
the music comprises a plurality of bars; and
the music player sets the length of the time from the position where a game was paused to the position where the music is restarted to a longer length the greater the number of tasks of the plurality of stored tasks there are that are set within the bar that includes the position where the game was paused.

9. A control method that is executed by a device comprising a task memory, a receiver, a music player, an object display and a score determiner; wherein
the task memory stores a plurality of tasks beforehand that indicate timing when a player is to input operation instructions;
the control method comprising steps of:
the receiver receiving an instruction from the player;
the music player playing music, stopping the music when the player inputs a pause instruction and restarting the music from a position in the music before the position where the music was stopped when the player inputs a restart instruction;
the object display displaying object images that indicate the stored tasks on a screen in pace with the played music, and displays only objects for which the timing has never occurred once since the music began to be played; and
the score determiner determining the player's score for each of the tasks based on the stored tasks and the inputted operation instructions.

10. A non-transitory information recording medium that stores a program for causing a computer to function as:
a task memory wherein a plurality of tasks are stored beforehand for indicating the timing when a player is to input an operation instruction;
a receiver that receives instructions from the player;
a music player that plays music, stops playing music when the player inputs a pause instruction, and restarts playing music from a position in the music before the position where the music was stopped when the player inputs a restart instruction;
an object display that displays object images that indicate the stored game tasks on a screen in pace with the played music, and displays only object images that indicate the tasks for which the timing has never occurred once since the music began to be played; and
a score determiner that determines the player's score for each of the tasks based on the stored tasks and the inputted operation instructions.
